(19) United States
(12) Patent Application Publication
(10) Pub. No.: US 2026/0257147 A1
(43) Pub. Date: Sep. 3, 2026

(54) DEVICE AND METHOD FOR REMOVING SILICATE FROM REVERSE OSMOSIS CONCENTRATE BY INDUCED CRYSTALLIZATION

(71) Applicant: Greentech Environment Co., Ltd., Beijing (CN)

(72) Inventors: Zehua LI, Beijing (CN); Mengyuan DUAN, Beijing (CN); Mu LIU, Beijing (CN); Kai SUN, Beijing (CN); Xikun ZHU, Beijing (CN); Huiming HAN, Beijing (CN); Yingqiang SU, Beijing (CN); Liyan ZHANG, Beijing (CN); Yashun LIU, Beijing (CN)

(21) Appl. No.: 19/653,489

(22) Filed: Apr. 21, 2026

Related U.S. Application Data
(63) Continuation of application No. PCT/CN2024/079286, filed on Feb. 29, 2024.

(30) Foreign Application Priority Data
Oct. 23, 2023 (CN) 202311371860.1

(51) Int. Cl. B01D 9/00; B01D 61/10; B07B 1/28; C02F 1/00; C02F 1/44; C02F 1/52

(52) U.S. Cl. CPC B01D 9/0063; B01D 9/0036; B01D 9/005; B01D 9/0081; B01D 61/10; C02F 1/008; C02F 1/5236; B01D 2009/0086; B01D 2311/08; B07B 1/28; C02F 1/441; C02F 2001/5218; C02F 2209/06; C02F 2303/24

(57) ABSTRACT

A device for removing silicate from reverse osmosis concentrate by induced crystallization, including an induced crystallization reactor, an acid distributor, a raw water distributor, a first silicate detector, a second silicate detector and a pH meter. An inner cavity of the induced crystallization reactor is divided into a crystallization reaction zone and a transition zone from bottom to top. The raw water distributor is provided at a bottom of the crystallization reaction zone. The acid distributor is located above the raw water distributor. The induced crystallization reactor is provided with a liquid inlet pipe. The liquid inlet pipe communicates with the raw water distributor. The first silicate detector and the pH meter are provided on the liquid inlet pipe. A top of the induced crystallization reactor is provided with a liquid outlet pipe. The second silicate detector is provided on the liquid outlet pipe.

### CROSS-REFERENCE TO RELATED APPLICATIONS

This application is a continuation of International Patent Application No. PCT/CN2024/079286, filed on Feb. 29, 2024, which claims the benefit of priority from Chinese Patent Application No. 202311371860.1, filed on Oct. 23, 2023. The content of the aforementioned application, including any intervening amendments thereto, is incorporated herein by reference in its entirety.

### TECHNICAL FIELD

This application relates to water treatment, and more particularly to a device and method for removing silicate from reverse osmosis concentrate by induced crystallization.

### BACKGROUND

In the reverse osmosis feed water and reverse osmosis concentrate, silicon typically exists in the form of free silicate or combined silicon dioxide, and its existing form is mainly influenced by the water pH. During the reverse osmosis filtration, the equivalent concentration of SiO₂ needs to be controlled below 100 mg/L in the absence of a scale and below 320 mg/L in the presence of a scale inhibitor. When the equivalent concentration of SiO₂ exceeds the limit value, solid SiO₂ will be precipitated, thereby clogging the reverse osmosis membrane.

In order to achieve zero discharge and resource recovery through a reverse osmosis process, it is typically needed to concentrate the salts in the feed water at a high concentration factor, thereby resulting in a significant increase in the equivalent concentration of SiO₂ in the concentrate. Consequently, fouling and scaling will occur in a subsequent secondary reverse osmosis process or other advanced treatment units. Therefore, in order to successfully achieve the recovery or compliant discharge of the reverse osmosis concentrate, it is necessary to perform efficient and advanced removal of silicate.

In terms of silicate removal, several methods have been developed, including magnesium-based silicate removal, sodium aluminate-based silicate removal, iron salt-based silicate removal, and dual-membrane removal. Obviously, the existing removal strategies are dominated by the addition of metal salts to form positively-charged metal hydroxide colloids in the water, which subsequently adsorb and precipitate negatively-charged silicate ions. However, such methods involve the introduction of additional metal ion impurities, and the resultant flocs can not settle in a rapid and stable manner.

Therefore, there is an urgent need to develop a device and method for removing silicate from reverse osmosis concentrate by induced crystallization to address the above problems.

### SUMMARY

An object of the disclosure is to provide a device and method for removing silicate from reverse osmosis concentrate by induced crystallization to overcome the defects in the prior art.

Technical solutions of the present disclosure are described as follows.

In a first aspect, this application provides a device for removing silicate from reverse osmosis concentrate by induced crystallization, comprising:
an induced crystallization reactor;
an acid distributor;
a raw water distributor;
a first silicate detector;
a second silicate detector;
a pH meter;
wherein the induced crystallization reactor has an inner cavity;
the inner cavity is divided into a crystallization reaction zone and a transition zone from bottom to top along a vertical direction;
the crystallization reaction zone is filled with silicon dioxide particles having a preset particle size;
the raw water distributor is provided at a bottom of the crystallization reaction zone;
the acid distributor is provided within the crystallization reaction zone, and is located above the raw water distributor;
the induced crystallization reactor is provided with a liquid inlet pipe and a sludge discharge pipe;
the liquid inlet pipe and the sludge discharge pipe are each in communication with the inner cavity, and are located at the bottom of the crystallization reaction zone;
the liquid inlet pipe is in communication with the raw water distributor;
the first silicate detector and the pH meter are provided on the liquid inlet pipe;
a top of the induced crystallization reactor is provided with a liquid outlet pipe; and
the second silicate detector is provided on the liquid outlet pipe.

In some embodiments, the number of the acid distributor is one; or
a plurality of acid distributors are provided; and along the vertical direction, the plurality of acid distributors are arranged spaced apart within the crystallization reaction zone, and are located above the raw water distributor.

In some embodiments, the device further comprises a dryer, a vibrating screen and a first storage tank;
the sludge discharge pipe is connected to the dryer;
the dryer is configured to calcine precipitates discharged from the sludge discharge pipe at a preset temperature; wherein the preset temperature is greater than or equal to 150° C.;
the vibrating screen is configured to separate silicon dioxide particles having different particle sizes; and
the first storage tank is configured to store the silicon dioxide particles having the preset particle size.

In some embodiments, the preset particle size of the silicon dioxide particles is 0.3 mm;
in response to a case that the crystallization reaction zone is filled with raw water, a ratio M of a total weight of the raw water to a total weight of the silicon dioxide particles in the crystallization reaction zone is less than or equal to 20;
the crystallization reaction zone has a cylindrical structure with a footprint area expressed as:

$$A = \frac{Q}{153.11} \times {( 1 + \frac{1}{2.65 M} )}^{4.65} ;$$

wherein A is the footprint area of the cylindrical structure, m²; and Q is a first preset flow rate at which the raw water flows into the crystallization reaction zone from the liquid inlet pipe, m³/h, and A is greater than

$$\frac{Q}{140.36}$$

and less than

$$\frac{Q}{4.44} ;$$

and
along the vertical direction, a height of the crystallization reaction zone satisfies:

$$H \geq \frac{( 2.65 M + 1 ) {m}_{s}}{2650 A} ;$$

wherein H represents the height of the crystallization reaction zone, m; and mₛ is the total weight of the silicon dioxide particles in the crystallization reaction zone, kg.

In some embodiments, the raw water distributor and the acid distributor each have a disc-shaped structure;
the acid distributor is provided with a plurality of first liquid distribution holes, and the raw water distributor is provided with a plurality of second liquid distribution holes; and the number of the plurality of first liquid distribution holes is the same as the number of the plurality of second liquid distribution holes;
the transition zone has an inverted truncated cone-shaped structure; and
along the vertical direction, an inner diameter of the inverted truncated cone-shaped structure is configured to increase from bottom to top.

In some embodiments, the device further comprises a second storage tank for storing an acid;
wherein the second storage tank is connected to the acid distributor via an acid dosing pipe; and the acid dosing pipe is provided with an acid dosing pump and an acid dosing valve.

In a second aspect, this application provides a method for removing silicate from reverse osmosis concentrate by induced crystallization, the method being performed based on the device described above, the device further comprising an automatic control system, the first silicate detector, the second silicate detector, the pH meter, the acid dosing pump and the acid dosing valve being connected to the automatic control system, and the method comprising:
introducing raw water into the crystallization reaction zone via the raw water distributor at a first preset flow rate, and simultaneously introducing a dilute sulfuric acid solution having a preset molar concentration into the crystallization reaction zone via the acid distributor at a second preset flow rate, such that a solid-liquid mixture in the crystallization reaction zone forms a fluidized bed state;
wherein the second preset flow rate is expressed as:

$${q}_{1} = \{ \begin{matrix}\frac{Q}{12 b} & a < 9 \\ \frac{Q \times 1 {0}^{a - 9}}{12 b} & a \geq 9\end{matrix} ;$$

wherein q₁ represents the second preset flow rate, mL/min; a is a pH value of the raw water; b is the preset molar concentration of the dilute sulfuric acid solution, mol/L; and Q is the first preset flow rate at which the raw water flows into the crystallization reaction zone from the liquid inlet pipe, m³/h;
measuring, by the pH meter, the pH value of the raw water at a preset frequency of n times per minute, detecting, by the first silicate detector, a silicate concentration C₀ of the raw water at a preset frequency of n times per minute, and detecting, by the second silicate detector, a silicate concentration C₁ of an effluent from the crystallization reaction zone at a preset frequency of n times per minute, wherein n is a positive integer;
calculating, by the automatic control system, a silicate removal rate R, wherein

$$R = \frac{{C}_{0} - {C}_{1}}{{C}_{0}} ;$$

and
when a slope of a curve of the silicate removal rate remains negative for a duration exceeding a preset time period, stopping introducing the raw water and the dilute sulfuric acid solution into the crystallization reaction zone, and discharging precipitates via the sludge discharge pipe.

In some embodiments, the number of the acid distributor is N, and N is an integer greater than or equal to 2;
N acid distributors are arranged spaced apart within the crystallization reaction zone along the vertical direction;
among the N acid distributors, a lowermost acid distributor is activated simultaneously with the raw water distributor;
after the lowermost acid distributor is activated, remaining N acid distributors among the N acid distributors are sequentially activated from bottom to top at an interval of 1 min; and
each of the N acid distributors is configured to introduce the dilute sulfuric acid solution into the crystallization reaction zone at a third preset flow rate, and the third preset flow rate is expressed as:

$${q}_{2} = \{ \begin{matrix}\frac{Q}{12 bN} & a < 9 \\ \frac{Q \times 1 {0}^{a - 9}}{12 bN} & a \geq 9\end{matrix} ;$$

wherein q₂ represents the third preset flow rate, in mL/min.

In some embodiments, N=INT(HRT)+1;
wherein HRT represents a hydraulic retention time in the crystallization reaction zone, min; and

$$H R T = 0.39 \times {( 1 + \frac{1}{2.65 M} )}^{4.65} H .$$

Compared to the prior art, the present disclosure has the following beneficial effects.
1. In the present disclosure, low-cost strong acids such as the dilute sulfuric acid solution are used to replace metal-containing agents in conventional silicate removal methods, and the dosage of the strong acids is precisely controlled, thereby significantly reducing chemical consumption while avoiding introduction of metal ion impurities.
2. During silicate removal, precipitated silicate crystals are adsorbed onto surfaces of the silicon dioxide seed particles, whereby the resulting products have low moisture content, are readily settled, and are recyclable after high-temperature calcination.
3. The occupied area and volume of the device can be flexibly adjusted according to practical engineering requirements, and sufficient separation of solid and liquid phases is achieved within the device without additionally providing facilities such as sedimentation tanks, filters, or separators, whereby low-turbidity effluent is obtained.

### BRIEF DESCRIPTION OF THE DRAWINGS

The accompanying drawings are provided to facilitate the understanding of the technical solutions of the present disclosure, and form a part of the specification to illustrate the disclosure together with the embodiments. The accompanying drawings are illustrative and exemplary, and are not intended to limit the disclosure.

In order to illustrate the technical solutions in the embodiments of the present disclosure or the prior art more clearly, the accompanying drawings needed in the description of the embodiments or prior art will be briefly described below. Obviously, presented in the accompanying drawings are only some embodiments of the present disclosure, and for those of ordinary skill in the art, other accompanying drawings can be obtained from the structures illustrated therein without making creative effort.

FIG. 1 is a structural view of a device for removing silicate from reverse osmosis concentrate by induced crystallization according to an embodiment of the present disclosure; and

FIG. 2 is a top view of an acid distributor and a raw water distributor according to an embodiment of the present disclosure.

In the figures: 1—induced crystallization reactor; 11—inner cavity; 111—crystallization reaction zone; 112—transition zone; 12—liquid inlet pipe; 121—liquid inlet pump; 122—liquid inlet valve; 13—sludge discharge pipe; 131—sludge discharge pump; 132—sludge discharge valve; 14—liquid outlet pipe; 15—overflow weir; 2—acid distributor; 21—first liquid distribution hole; 3—raw water distributor; 31—second liquid distribution hole; 4—first silicate detector; 5—second silicate detector; 6—pH meter; 7—second storage tank; 71—acid dosing pipe; 72—acid dosing pump; 73—acid dosing valve; 8—dryer; 9—vibrating screen; and 10—first storage tank.

### DETAILED DESCRIPTION OF EMBODIMENTS

To facilitate the understanding of the objectives, features, and advantages of the present disclosure, the disclosure will be described in detail below with reference to embodiments and accompanying drawings. It should be noted that the embodiments of the present disclosure and the features therein may be combined in the absence of contradiction.

Many specific details are provided below to facilitate a comprehensive understanding of the present disclosure. However, it should be noted that the disclosure may be implemented in ways other than those explicitly described herein. It is obvious that described herein are merely some embodiments of the present disclosure, instead of all embodiments.

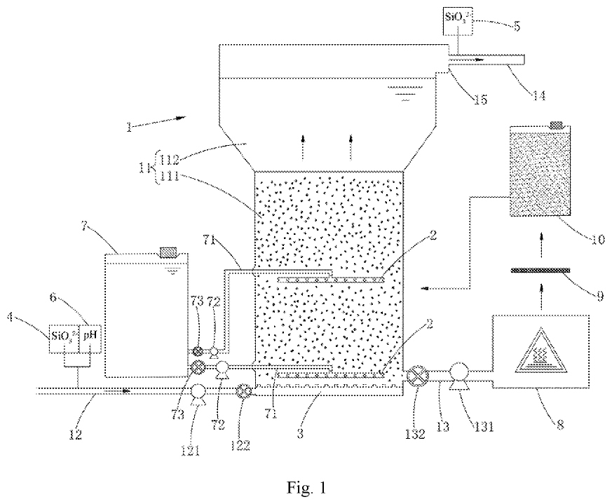

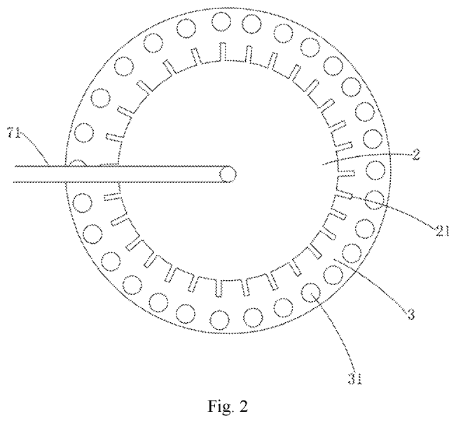

As shown in FIGS. 1 and 2, an embodiment of the present disclosure provides a device for removing silicate from reverse osmosis concentrate by induced crystallization. The device includes an induced crystallization reactor 1, an acid distributor 2, a raw water distributor 3, a first silicate detector 4, a second silicate detector 5 and a pH meter 6. The induced crystallization reactor 1 has an inner cavity 11. The inner cavity 11 is divided into a crystallization reaction zone 111 and a transition zone 112 from bottom to top along a vertical direction. The crystallization reaction zone 111 is filled with silicon dioxide particles having a preset particle size. The raw water distributor 3 is provided at a bottom of the crystallization reaction zone 111. The acid distributor 2 is provided within the crystallization reaction zone 111, and is located above the raw water distributor 3. The induced crystallization reactor 1 is provided with a liquid inlet pipe 12 and a sludge discharge pipe 13. The liquid inlet pipe 12 and the sludge discharge pipe 13 are each in communication with the inner cavity 11, and are located at the bottom of the crystallization reaction zone 111. The liquid inlet pipe 12 is in communication with the raw water distributor 3. The first silicate detector 4 and the pH meter 6 are provided on the liquid inlet pipe 12. A top of the induced crystallization reactor 1 is provided with a liquid outlet pipe 14. The second silicate detector 5 is provided on the liquid outlet pipe 14.

It can be appreciated that, due to the presence of concentrated impurities such as carbonates and silicates, reverse osmosis concentrate is typically alkaline. Therefore, hydrogen ions are introduced into the raw water to drive a hydrolysis reaction of silicate in a forward direction. The relevant chemical reaction is as follows:

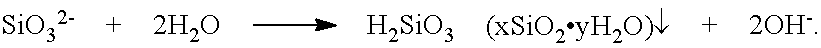

Further, silicon dioxide particles having the preset particle size are filled in the crystallization reaction zone 111 as crystal-inducing carrier. The raw water enters from a lower portion of the crystallization reaction zone 111 and flows upward, such that the silicon dioxide particles are in a fluidized bed state. Free silicate in the raw water precipitates in the form of silicate crystals and is adsorbed onto surfaces of the silicon dioxide particles. Compared with conventional techniques, silicate can be removed without introducing metal impurity ions, and the silicon dioxide particles ensure low moisture content and excellent settling performance, thereby facilitating discharge through the sludge discharge pipe 13.

In some embodiments, the preset particle size of the silicon dioxide particles is 0.3 mm, such that the silicon dioxide particles can provide a relatively large specific surface area while preventing the particles from floating due to pulverization.

Further, by providing the first silicate detector 4 and the second silicate detector 5, silicate concentrations of the raw water entering and exiting the induced crystallization reactor 1 can be respectively measured, thereby allowing calculation of a silicate removal rate. For example, when a silicate concentration detected by the first silicate detector 4 is C₀ and a silicate concentration detected by the second silicate detector 5 is C₁, the silicate removal rate R is given by

$$R = \frac{{C}_{0} - {C}_{1}}{{C}_{0}} .$$

When a slope of a curve of the silicate removal rate remains negative for a duration exceeding a preset time period, it is determined that adsorption performance of the silicon dioxide particles in the crystallization reaction zone 111 has reached a limit. At this point, precipitates are discharged through the sludge discharge pipe 13, and fresh silicon dioxide particles are supplemented into the crystallization reaction zone 111.

Further, by providing the pH meter 6, the pH value of the raw water can be detected, thereby enabling precise calculation of an acid dosing amount in the crystallization reaction zone 111, so as to ensure sufficient crystallization while controlling chemical consumption.

In addition, silicate crystals are adsorbed onto surfaces of the silicon dioxide particles and, after high-temperature calcination, are decomposed into silicon dioxide, which can be recycled, thereby reducing costs.

In some embodiments, the number of the acid distributor 2 is one. Specifically, when a hydraulic retention time (HRT) in the crystallization reaction zone 111 is less than or equal to 1 min, the number of the acid distributor 2 is one. The HRT is defined as a ratio of a first preset flow rate to a volume of the crystallization reaction zone 111.

In some embodiments, a plurality of acid distributors 2 are provided. In the vertical direction, the plurality of acid distributors 2 are arranged spaced apart within the crystallization reaction zone 111, and are located above the raw water distributor 3.

Specifically, when the HRT in the crystallization reaction zone 111 is greater than 1 min, the number of the acid distributors is INT(HRT)+1, where INT is a floor function. A hydraulic retention time between two adjacent acid distributors 2 in the vertical direction is 1 min. With such an arrangement of the acid distributors 2, the raw water is ensured to continuously mix with newly introduced acid during upward flow, such that precipitation of silicate crystals can proceed continuously and sufficiently within the crystallization reaction zone 111, thereby improving the silicate removal rate.

In this embodiment, with reference to FIG. 1, the number of the acid distributor is two. Alternatively, the acid distributor may be provided in one, three, or three or more.

In some embodiments, the device further includes a dryer 8, a vibrating screen 9 and a first storage tank 10. The sludge discharge pipe 13 is connected to the dryer 8. The dryer 8 is configured to dry precipitates discharged from the sludge discharge pipe 13. The first storage tank 10 is configured to store the silicon dioxide particles having the preset particle size.

By providing the dryer 8 and the vibrating screen 9, the dryer 8 is configured to calcine the precipitates discharged from the sludge discharge pipe 13 at a high temperature of greater than or equal to 150° C., such that silicic acid is decomposed to obtain silicon dioxide. The chemical reaction equation is as follows:

H₂SiO₃→SiO₂+H₂O.

Subsequently, silicon dioxide particles having the preset particle size are screened by the vibrating screen 9, such that the silicon dioxide particles can be recovered and stored in the first storage tank 10, thereby reducing costs. In addition, since the adsorption capacity of the silicon dioxide particles in the crystallization reaction zone 111 decreases after a period of operation, fresh silicon dioxide particles may be added into the crystallization reaction zone 111 from the first storage tank 10.

Further, the sludge discharge pipe 13 is provided with a sludge discharge pump 131 and a sludge discharge valve 132. By opening the sludge discharge valve 132 and operating the sludge discharge pump 131, precipitates in the crystallization reaction zone 111 are delivered into the dryer 8 for high-temperature calcination.

In some embodiments, with reference to FIG. 1, the device further includes a second storage tank 7 for storing an acid. The second storage tank 7 is connected to the acid distributor 2 via an acid dosing pipe 71. The acid dosing pipe 71 is provided with an acid dosing pump 72 and an acid dosing valve 73.

In this embodiment, with reference to FIG. 1, two acid distributors 2 are provided. Correspondingly, two acid dosing pipes 71 are provided. One of the acid dosing pipes 71 is in communication with one of acid distributors 2, and the other of the acid dosing pipes 71 is in communication with the other of acid distributors 2. Each acid dosing pipe 71 is provided with the acid dosing pump 72 and the acid dosing valve 73.

In some embodiments, with reference to FIG. 1, the liquid inlet pipe 12 is provided with a liquid inlet pump 121 and a liquid inlet valve 122. A flow rate of the raw water introduced into the crystallization reaction zone 111 is controlled by the liquid inlet pump 121 and the liquid inlet valve 122.

In some embodiments, the preset particle size of the silicon dioxide particles is 0.3 mm. When the crystallization reaction zone 111 is filled with raw water, a ratio M of a total weight of the raw water to a total weight of the silicon dioxide particles in the crystallization reaction zone 111 is less than or equal to 20.

Further, the crystallization reaction zone 111 has a cylindrical structure with a footprint area expressed as:

$$A = \frac{Q}{153.11} \times {( 1 + \frac{1}{2.65 M} )}^{4.65} .$$

In the above formula, A is the footprint area of the cylindrical structure, m²; and Q is a first preset flow rate at which the raw water flows into the crystallization reaction zone 111 from the liquid inlet pipe 12, m³/h, and A is greater than

$$\frac{Q}{140.36}$$

and less than

$$\frac{Q}{4.44} .$$

Further, in the vertical direction, a height of the crystallization reaction zone 111 satisfies:

$$H \geq \frac{( 2.65 M + 1 ) {m}_{s}}{2650 A} .$$

In the above formula, H represents the height of the crystallization reaction zone 111, m; and mₛ is a total weight of the silicon dioxide particles in the crystallization reaction zone 111, kg.

Such an arrangement ensures that an upper surface of a fluidized bed formed by the raw water and the silicon dioxide particles is flush with an interface between the crystallization reaction zone 111 and the transition zone 112, and that a superficial velocity of the raw water within the crystallization reaction zone 111 does not reach a starting transport velocity. Accordingly, sufficient contact between the silicon dioxide particles and the raw water is ensured, while dispersion and loss of the silicon dioxide particles are avoided.

Specifically, the above formula is derived through theoretical analysis and experimental verification, and its feasibility has been demonstrated. Reference formulas include:

$${u}_{mf} = \frac{{ε}_{0}^{3} {d}_{p}^{2} * ( {ρ}_{p} - {ρ}_{l} ) * g}{150 μ ( 1 - {ε}_{0} )} ;$$

$${u}_{mt} = \frac{{d}_{p}^{2} * ( {ρ}_{p} - {ρ}_{l} ) * g}{18 μ} ;$$

$$E = \frac{H - {H}_{0}}{{H}_{0}} = \frac{{ε}_{l} - {ε}_{0}}{1 - {ε}_{l}} ;$$

$${ε}_{l} = \sqrt[n]{\frac{u}{{u}_{0}}} ;$$

$${u}_{0} = \frac{μ}{{ρ}_{l} * {d}_{p}} {( 2.33 {G}_{a}^{0.018} - 1.53 {G}_{a}^{- 0.016} )}^{13.3} ;$$

$$\frac{4.8 - n}{n - 2.4} = 0.0 \; 43 {Ga}^{0.57} [ 1 - 1.24 {( {d}_{p} / D )}^{0.24} ] ; and$$

$$( When Re < 0.2 , n = 4.65 + \frac{20 {d}_{p}}{D} \approx 4.65 )$$

$$Ga = {ρ}_{l} \cdot {d}_{p}^{3} ( {ρ}_{p} - {ρ}_{l} ) \frac{g}{{μ}^{2}} .$$

In the above formulas, u_{mf} represents a minimum fluidization velocity of the fluidized bed; uₘₜ represents a minimum transport velocity of the fluidized bed; E represents an expansion ratio of the fluidized bed; u represents a superficial velocity of the fluid; u₀ represents a terminal settling velocity of quartz particles; n represents a correction parameter; Re represents a Reynolds number of the fluid; Ga represents a Galileo number; dₚ represents a particle size of 0.3×10⁻³ m; D represents a diameter of the crystallization reaction zone; ρₚ represents a particle density of 2.65×10³ kg/m³; ρₗ represents a fluid density of 1.0×10³ kg/m³; g represents gravitational acceleration of 9.8 m/s²; μ represents a fluid viscosity of 1.005×10⁻³ Pa's (at 20° C.); ε₀ represents a porosity of a quartz particle bed in a packed state; and ε₁ represents a porosity of the quartz particle bed in a fluidized state.

In some embodiments, with reference to FIG. 1, the transition zone 112 has an inverted truncated cone-shaped structure, and in the vertical direction, an inner diameter of the inverted truncated cone-shaped structure is configured to increase from bottom to top. Such an arrangement enables a velocity of upward flow of raw water to decrease after entering the transition zone 112, thereby facilitating the return of silicon dioxide particles that enter the transition zone 112 to the crystallization reaction zone 111.

Further, the top of the induced crystallization reactor 1 is provided with an overflow weir 15. The overflow weir 15 allows the raw water within the induced crystallization reactor 1 to overflow uniformly, thereby preventing the raw water from escaping and adversely affecting fluid flow in the transition zone 112 and the crystallization reaction zone 111.

In some embodiments, with reference to FIG. 2, the raw water distributor 3 and the acid distributor 2 each have a disc-shaped structure. The acid distributor 2 is provided with a plurality of first liquid distribution holes 21, and the raw water distributor 3 is provided with a plurality of second liquid distribution holes 31. The number of the first liquid distribution holes 21 is the same as the number of the second liquid distribution holes 31, thereby facilitating sufficient mixing of the acid and the raw water and promoting rapid crystallization of free silicate in the raw water.

The device further includes an automatic control system. The first silicate detector 4, the second silicate detector 5 and the pH meter 6 are all connected to the automatic control system. In addition, the sludge discharge valve 132, the sludge discharge pump 131, the acid dosing valve 73, the acid dosing pump 72, the liquid inlet valve 122 and the liquid inlet pump 121 are all connected to the automatic control system. In some embodiments, the automatic control system is a Programmable Logic Controller (PLC)-based automatic control system, such that the device provided herein is capable of fully automatic and digital operation.

In summary, the device provided herein can flexibly adjust its occupied area and volume according to actual requirements, without the need for additional sedimentation tanks, filters or separators, such that the solid phase and the liquid phase within the crystallization reaction zone 111 are sufficiently separated, thereby effectively removing silicate from the raw water.

The present disclosure also provides a method for removing silicate from reverse osmosis concentrate by induced crystallization. The method is performed based on the device described above, and the method including the following steps.
(S1) Raw water is introduced into the crystallization reaction zone 111 through the raw water distributor 3 at the first preset flow rate, while a dilute sulfuric acid solution having a preset molar concentration is introduced into the crystallization reaction zone 111 through the acid distributor 2 at a second preset flow rate, such that a solid-liquid mixture within the crystallization reaction zone forms a fluidized bed state.

The second preset flow rate is expressed as:

$${q}_{1} = \{ \begin{matrix}\frac{Q}{12 b} & a < 9 \\ \frac{Q \times 1 {0}^{a - 9}}{12 b} & a \geq 9\end{matrix} .$$

In the above formula, q₁ represents the second preset flow rate, mL/min; a is a pH value of the raw water; and b is the preset molar concentration of the dilute sulfuric acid solution, mol/L.
(S2) The pH value of the raw water is measured by the pH meter 6 at a preset frequency of n times per minute, a silicate concentration C₀ of the raw water is detected by the first silicate detector 4 at a preset frequency of n times per minute, and a silicate concentration C₁ of an effluent from the crystallization reaction zone 111 is detected by the second silicate detector 5 at a preset frequency of n times per minute, where n is a positive integer. A silicate removal rate R is calculated by the automatic control system, where

$$R = \frac{{C}_{0} - {C}_{1}}{{C}_{0}} .$$

When a slope of a curve of the silicate removal rate continuously remains negative for a duration exceeding a preset time period, introduction of the raw water and the dilute sulfuric acid solution into the crystallization reaction zone is stopped, and precipitates are discharged through the sludge discharge pipe.

Specifically, the liquid inlet pump 121 and the acid dosing pump 72 are controlled to be stopped by the automatic control system, and the liquid inlet valve 122 and the acid dosing valve 73 are controlled to be closed, such that introduction of the raw water and the acid into the crystallization reaction zone 111 is stopped. Subsequently, the sludge discharge valve 132 is controlled to be opened and the sludge discharge pump 131 is controlled to be activated by the automatic control system, such that precipitates within the crystallization reaction zone 111 are discharged through the sludge discharge pipe 13.

In some embodiments, the acid is the dilute sulfuric acid solution, as it is capable of providing more hydrogen ions at an equivalent dosage to promote hydrolysis of silicate and crystallization of silicic acid. In some embodiments, n is 1, that is, the pH meter 6, the first silicate detector 4 and the second silicate detector 5 are configured to perform measurements once per minute.

In some embodiments, the number of the acid distributor 2 is N, where Nis an integer greater than or equal to 2. N acid distributors 2 are arranged spaced apart within the crystallization reaction zone 111 along the vertical direction. Among the N acid distributors, a lowermost acid distributor is activated simultaneously with the raw water distributor 3.

Accordingly, in step (S1), after the lowermost acid distributor is activated, remaining acid distributors 2 among the N acid distributors 2 are sequentially activated from bottom to top at an interval of 1 min. Each of the N acid distributors 2 is configured to introduce the dilute sulfuric acid solution into the crystallization reaction zone 111 at a third preset flow rate. The third preset flow rate is expressed as:

$${q}_{2} = \{ \begin{matrix}\frac{Q}{12 bN} & a < 9 \\ \frac{Q \times 1 {0}^{a - 9}}{12 bN} & a \geq 9\end{matrix} .$$

In the above formula, q₂ represents the third preset flow rate, mL/min.

It can be understood that, as the raw water flows upward from a bottom toward a top of the crystallization reaction zone 111, the acid distributors 2 are arranged at intervals corresponding to a hydraulic retention time of 1 minute during the upward flow, that is, acid is introduced in batches. Such an arrangement enables the raw water to continuously mix with newly introduced acid during the upward flow, thereby promoting the forward hydrolysis reaction of silicate and suppressing a reverse shift of the reaction equilibrium, which is conducive to improving the silicate removal efficiency.

In some embodiments, after the precipitates in the crystallization reaction zone 111 are discharged through the sludge discharge pipe 13, a preset weight of silicon dioxide particles is reintroduced into the crystallization reaction zone 111, and introduction of the raw water and the acid into the crystallization reaction zone 111 is restarted, that is, steps S1 and S2 are repeated.

Regarding the method provided herein, hydrogen ions are introduced into the raw water to promote hydrolysis of free silicate in the raw water, whereby the silicate is precipitated in the form of silica crystals and is adsorbed by silicon dioxide particles serving as crystal-inducing carrier. Compared with the prior art, the introduction of metal impurity particles is avoided. In addition, the silicon dioxide particles provide excellent settling performance and ensure that the resulting precipitates have a relatively low moisture content, thereby facilitating discharge of the precipitates through the sludge discharge pipe 13. Furthermore, the silicon dioxide particles contained in the precipitates can be recovered after high-temperature calcination and sieving by the vibrating screen 9, thereby reducing costs.

It should be noted that, as used herein, terms such as “first” and “second” are only descriptive, and should not be construed as indicating or implying their relative importance or implicitly specifying the number of technical features indicated. Moreover, the terms “comprise”, “include” or any other variants thereof are intended to cover non-exclusive inclusion, such that a process, method, article, or apparatus that comprises a list of elements does not include only those elements, but may also include other elements not expressly listed or elements inherent to such process, method, article, or apparatus. In the absence of additional limitations, an element defined by the phrase “comprising a . . . ” does not exclude the presence of additional elements of the same type in a process, method, article, or apparatus that comprises the stated element.

Described embodiments are merely illustrative, and are not intended to limit the scope of the present disclosure. It should be understood that various modifications, changes and replacements made by those skilled in the art without departing from the spirit of the disclosure shall fall within the scope of the present disclosure defined by the appended claims.

What is claimed is:

1. A device for removing silicate from reverse osmosis concentrate by induced crystallization, comprising:
an induced crystallization reactor;
an acid distributor;
a raw water distributor;
a first silicate detector;
a second silicate detector;
a pH meter;
a dryer;
a vibrating screen; and
a first storage tank;
wherein the induced crystallization reactor has an inner cavity;
the inner cavity is divided into a crystallization reaction zone and a transition zone from bottom to top along a vertical direction;
the crystallization reaction zone is filled with silicon dioxide particles having a preset particle size;
the raw water distributor is provided at a bottom of the crystallization reaction zone;
the acid distributor is provided within the crystallization reaction zone, and is located above the raw water distributor;
the raw water distributor and the acid distributor each have a disc-shaped structure;
the acid distributor is provided with a plurality of first liquid distribution holes, and the raw water distributor is provided with a plurality of second liquid distribution holes; and the number of the plurality of first liquid distribution holes is the same as the number of the plurality of second liquid distribution holes;
the induced crystallization reactor is provided with a liquid inlet pipe and a sludge discharge pipe;
the liquid inlet pipe and the sludge discharge pipe are each in communication with the inner cavity, and are located at the bottom of the crystallization reaction zone;
the liquid inlet pipe is in communication with the raw water distributor;
the first silicate detector and the pH meter are provided on the liquid inlet pipe;
a top of the induced crystallization reactor is provided with a liquid outlet pipe;
the second silicate detector is provided on the liquid outlet pipe;
the sludge discharge pipe is connected to the dryer;
the dryer is configured to calcine precipitates discharged from the sludge discharge pipe at a preset temperature; wherein the preset temperature is greater than or equal to 150° C.;
the vibrating screen is configured to separate silicon dioxide particles having different particle sizes; and
the first storage tank is configured to store the silicon dioxide particles having the preset particle size.

2. The device of claim 1, wherein the number of the acid distributor is one; or
a plurality of acid distributors are provided; and along the vertical direction, the plurality of acid distributors are arranged spaced apart within the crystallization reaction zone, and are located above the raw water distributor.

3. The device of claim 1, wherein the preset particle size of the silicon dioxide particles is 0.3 mm;
in response to a case that the crystallization reaction zone is filled with raw water, a ratio M of a total weight of the raw water to a total weight of the silicon dioxide particles in the crystallization reaction zone is less than or equal to 20;
the crystallization reaction zone has a cylindrical structure with a footprint area expressed as:
$$A = \frac{Q}{153.11} \times {( 1 + \frac{1}{2.65 M} )}^{4.65} ;$$
wherein A is the footprint area of the cylindrical structure, m²; and Q is a first preset flow rate at which the raw water flows into the crystallization reaction zone from the liquid inlet pipe, m³/h, and A is greater than
$$\frac{Q}{140.36}$$
and less than
$$\frac{Q}{4.44} ;$$
and
along the vertical direction, a height of the crystallization reaction zone satisfies:
$$H \geq \frac{( 2.65 M + 1 ) {m}_{s}}{2650 A} ;$$
wherein H represents the height of the crystallization reaction zone, m; and mₛ is the total weight of the silicon dioxide particles in the crystallization reaction zone, kg.

4. The device of claim 1, wherein the transition zone has an inverted truncated cone-shaped structure; and
along the vertical direction, an inner diameter of the inverted truncated cone-shaped structure is configured to increase from bottom to top.

5. The device of claim 1, further comprising:
a second storage tank for storing an acid;
wherein the second storage tank is connected to the acid distributor via an acid dosing pipe; and the acid dosing pipe is provided with an acid dosing pump and an acid dosing valve.

6. A method for removing silicate from reverse osmosis concentrate by induced crystallization, the method being performed based on the device of claim 5, the device further comprising an automatic control system, the first silicate detector, the second silicate detector, the pH meter, the acid dosing pump and the acid dosing valve being connected to the automatic control system, and the method comprising:
introducing raw water into the crystallization reaction zone via the raw water distributor at a first preset flow rate, and simultaneously introducing a dilute sulfuric acid solution having a preset molar concentration into the crystallization reaction zone via the acid distributor at a second preset flow rate, such that a solid-liquid mixture in the crystallization reaction zone forms a fluidized bed state;
wherein the second preset flow rate is expressed as:
$${q}_{1} = \{ \begin{matrix}\frac{Q}{12 b} & a < 9 \\ \frac{Q \times 1 {0}^{a - 9}}{12 b} & a \geq 9\end{matrix} ;$$
wherein q₁ represents the second preset flow rate, mL/min; a is a pH value of the raw water; b is the preset molar concentration of the dilute sulfuric acid solution, mol/L; and Q is the first preset flow rate at which the raw water flows into the crystallization reaction zone from the liquid inlet pipe, m³/h;
measuring, by the pH meter, the pH value of the raw water at a preset frequency of n times per minute, detecting, by the first silicate detector, a silicate concentration C₀ of the raw water at a preset frequency of n times per minute, and detecting, by the second silicate detector, a silicate concentration C₁ of an effluent from the crystallization reaction zone at a preset frequency of n times per minute, wherein n is a positive integer;
calculating, by the automatic control system, a silicate removal rate R, wherein
$$R = \frac{{C}_{0} - {C}_{1}}{{C}_{0}} ;$$
and
when a slope of a curve of the silicate removal rate remains negative for a duration exceeding a preset time period, stopping introducing the raw water and the dilute sulfuric acid solution into the crystallization reaction zone, and discharging precipitates via the sludge discharge pipe.

7. The method of claim 6, wherein the number of the acid distributor is N, and N is an integer greater than or equal to 2;
N acid distributors are arranged spaced apart within the crystallization reaction zone along the vertical direction;
among the N acid distributors, a lowermost acid distributor is activated simultaneously with the raw water distributor;
after the lowermost acid distributor is activated, remaining acid distributors among the N acid distributors are sequentially activated from bottom to top at an interval of 1 min; and
each of the N acid distributors is configured to introduce the dilute sulfuric acid solution into the crystallization reaction zone at a third preset flow rate, and the third preset flow rate is expressed as:
$${q}_{2} = \{ \begin{matrix}\frac{Q}{12 bN} & a < 9 \\ \frac{Q \times 1 {0}^{a - 9}}{12 bN} & a \geq 9\end{matrix} ;$$
wherein q₂ represents the third preset flow rate, mL/min.

8. The method of claim 7, wherein N=INT(HRT)+1;
wherein HRT represents a hydraulic retention time in the crystallization reaction zone, min; and
$$H R T = 0. 39 \times {( 1 + \frac{1}{2.65 M} )}^{4.65} H .$$
